(19) United States
(12) Patent Application Publication
(10) Pub. No.: US 2011/0005860 A1
(43) Pub. Date: Jan. 13, 2011

(54) EXHAUST COMPONENT WITH REDUCED PACK

(76) Inventors: Kwin Abram, Columbus, IN (US); Robin Willats, Columbus, IN (US); Ivan Arbuckle, Columbus, IN (US); Joseph Callahan, Greenwood, IN (US); James Egan, Indianapolis, IN (US)

Correspondence Address: PAMELA A. KACHUR, 577 W Santee Drive, Greensburg, IN, 47240, US

(21) Appl. No.: 12/501,529

(22) Filed: Jul. 13, 2009

(51) Int. Cl. F01N 1/10; F01N 1/08; B23P 17/00

(52) U.S. Cl. 181/252; 181/264; 29/890.08

(57) ABSTRACT

A vehicle exhaust component provides comparable fully packed noise reduction capability without requiring a fully packed configuration. A pack is mounted within an internal cavity defined by an exhaust component body. A plurality of pack positions are defined within the internal cavity and at least one pack is positioned at a desired pack position to provide a desired noise reduction.

### TECHNICAL FIELD

The subject invention relates to an exhaust component, such as a muffler for example, which provides a fully packed noise reduction capability without requiring a fully packed configuration.

### BACKGROUND OF THE INVENTION

A vehicle exhaust system component, such as a muffler for example, transmits exhaust gases through an exhaust component body from an inlet to an outlet. Typically, fibrous material such as fiberglass, Basalt, etc., is incorporated into the exhaust component body to reduce noise transmissions that are generated as exhaust gases flow from the inlet to the outlet. The material is used to fill all open space within an internal cavity defined within the exhaust component body to provide a fully packed configuration.

One disadvantage with fully filling the cavity with this material is cost and increased weight. Further, installing this material within the exhaust component body is time consuming and difficult to handle within the production process.

### SUMMARY OF THE INVENTION

A vehicle exhaust component provides a fully packed noise reduction capability without requiring a fully packed configuration.

In one example, the exhaust component comprises an exhaust body having first and second opposing ends and which defines an internal cavity with an inlet and an outlet. Exhaust gases are directed through the exhaust body from the inlet to the outlet. The exhaust body is defined by a plurality of dimensions with one of the plurality of dimensions comprising a longest dimension. A pack is positioned within the internal cavity at a pack distance that is at least 20% from either of the first and second opposing ends along an axis defined by the longest dimension. In a further example, the pack distance is within a range of 20% to 60%.

In one example, the pack comprises a body of compressed fibrous material formed as a single-piece. The body can be placed within one of a plurality of pack positions within the specified ranges to provide a desired noise reduction.

In another example, the pack has a thickness defined in a direction along the axis defined by the longest dimension wherein the thickness is no more than 25% of the longest dimension. In a further contemplated example, the thickness is within a range of 2% to 25%.

In another example, at least one perforated pipe is positioned within the internal cavity and the pack is mounted around an outer surface of the perforated pipe to extend along a substantial length of the perforated pipe. In this example, the pack fills no more than 50% of a total open cross-sectional area of the internal cavity to leave a gap between an outer surface of the pack and an inner wall surface of the exhaust body.

In one example, a baffle is located within the internal cavity. The pack is attached to the baffle.

In another example, at least one ¼ wave tuner is located within the internal cavity. The ¼ wave tuner cooperates with the pack to further reduce undesirable noise.

An example method of assembling the pack within the exhaust component includes the steps of defining a plurality of pack positions within the internal cavity, selecting at least one pack position based upon a desired noise reduction parameter, and positioning at least one pack in the selected pack position. Examples of pack positions are described above.

These and other features of the present invention can be best understood from the following specification and drawings, the following of which is a brief description.

### BRIEF DESCRIPTION OF THE DRAWINGS

FIG. 1A comprises a schematic cross-sectional view of one example of a pack optimally positioned within an exhaust component.

FIG. 1B comprises a schematic perspective view of the exhaust component and pack of FIG. 1A.

FIG. 2A comprises a schematic cross-sectional view of one example of a pack optimally positioned within an exhaust component in combination with two ¼ wave tuners.

FIG. 2B comprises a schematic perspective view of the exhaust component, pack, and tuners of FIG. 2A.

FIG. 3A comprises a schematic cross-sectional view of one example of a pack optimally positioned within an exhaust component in combination with a single ¼ wave tuner.

FIG. 3B comprises a schematic perspective view of the exhaust component, pack, and tuner of FIG. 3A.

FIG. 4 comprises a schematic cross-sectional view of a pack mounted to a baffle.

FIG. 5A comprises a perspective view of a perforated pipe to be installed within an exhaust component.

FIG. 5B shows the perforated pipe of FIG. 5A with a radially located pack.

FIG. 5C is a schematic cross-sectional view of the perforated pipe and pack of FIG. 5B installed within an exhaust component.

FIG. 5D comprises a schematic perspective view of the exhaust component, pipe, and pack of FIG. 5C.

### DETAILED DESCRIPTION OF THE PREFERRED EMBODIMENT

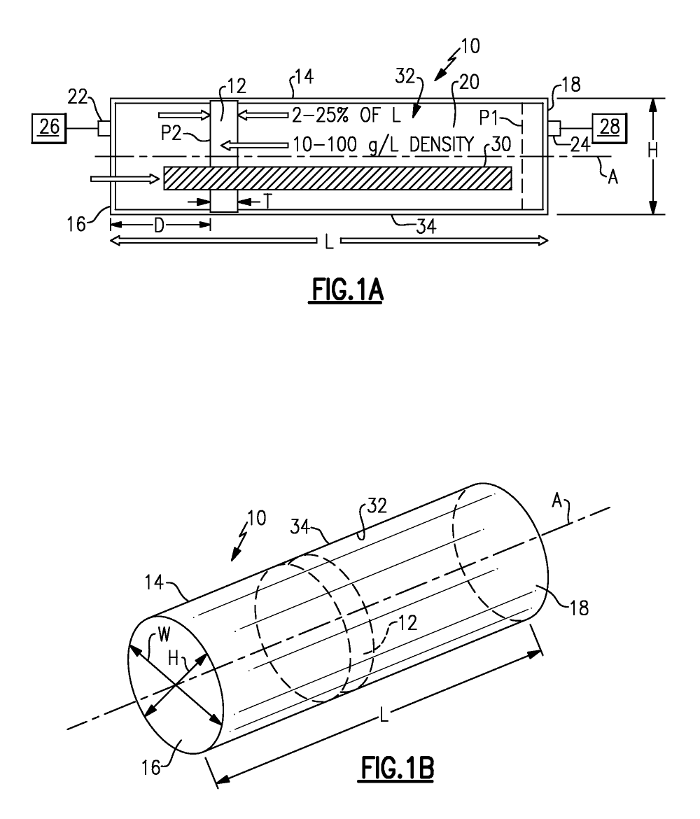

FIGS. 1A-1B show one example of an exhaust component 10 for a vehicle exhaust system that includes a pack 12 that is optimally located within the exhaust component 10 to provide noise reduction capability that is comparable to a fully packed configuration without actually requiring the exhaust component 10 to be fully packed. The pack 12 is assembled within the exhaust component 10 in one of a plurality of different pack positions. A pack position is selected based upon a desired noise reduction parameter, which can vary between different types, sizes and applications of the exhaust component 10.

As shown in FIGS. 1A and 1B, the exhaust component includes an exhaust body 14 having first 16 and second 18 opposing ends, and which defines an internal cavity 20. The exhaust body 14 has an inlet 22 and an outlet 24 where exhaust gases are directed through the exhaust body 14 from the inlet 22 to the outlet 24. End caps are mounted to the first 16 and second 18 ends as known. The inlet 22 receives exhaust gases from an engine or other upstream exhaust component 26 and the outlet 24 directs gases downstream to a tail pipe or other exhaust component 28.

In one example, the exhaust body 14 comprises an outer shell of a muffler. The pack 12 is installed within the internal cavity 20 of the muffler to provide the desired noise reduction parameter. The positioning of the pack 12 will be discussed in greater detail below.

The pack 12 is comprised of a fibrous material such as fiberglass, Basalt, etc. that is used within exhaust components. In the example shown, the pack 12 comprises a disc body that is formed from the fibrous material and which is compacted or contained as a single piece. This single piece is easily installed within the internal cavity 20 at the desired pack position.

The exhaust body is defined by a plurality of dimensions such as a length L, a height H, and a width W (FIG. 1B), for example. One of the plurality of dimensions comprises a longest dimension. In the example of FIGS. 1A-1B, the longest dimension corresponds to the length L. The pack 12 is positioned within the internal cavity 20 at a pack distance D that is at least 20% of the length L from either of the first 16 and the second 18 ends along an axis A defined by the length L. In one example, the pack distance D is within a range of 20% to 60% of the length from either of the first 16 and the second 18 ends along the axis A. This range is indicated at 30 in FIG. 1A. FIG. 1B shows the pack 12 at one example pack position within this range 30.

The exhaust body 14 is shown in this example as a circular tube with the pack 12 comprising a corresponding circular, disc-shaped body. It should be understood that the exhaust body and pack 12 could be formed to have other shapes, such as oval, square, or rectangular for example.

Another important characteristic of the pack 12 that cooperates with optimal pack position to further improve noise reduction is the thickness T of the pack 12. In one example, the pack 12 has a thickness T defined along the axis A that is no more than 25% of the length L. In a further example, the thickness T is defined within a range of 2% to 25% of the length L.

Another important characteristic of the pack 12 that cooperates with optimal pack position and pack thickness T to further improve noise reduction is the density of the fibrous material used to form the pack 12. In one example, the pack 12 is comprised of a fibrous material having a density within a range of 10 to 150 grams per liter.

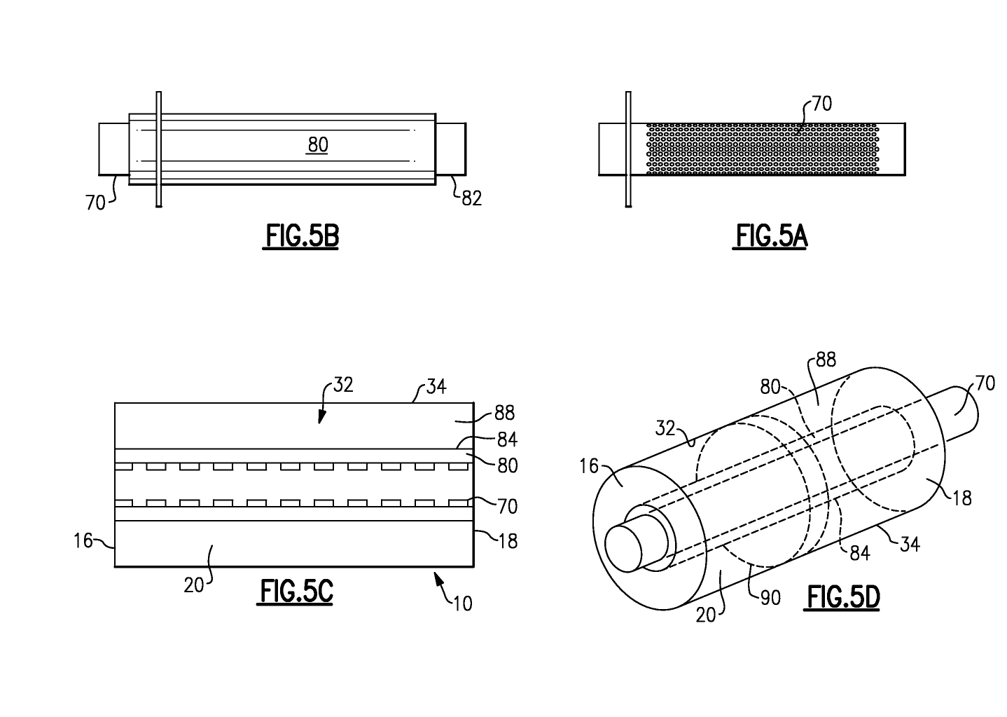

As shown in FIGS. 1A and 1B, the internal cavity 20 of the exhaust body 14 is defined by an inner wall 32 of an outer shell 34. The internal cavity 20 defines a cross-section that forms a plane P1 that is normal to the axis A. A cross-section of the pack 12 comprises a plane P2, normal to the axis A, which covers the entire cross-section of the internal cavity 20. Thus, the pack 12 provides coverage of the entire cross-section (height H times width W) of the internal cavity 20 of the exhaust component 10; however, in configurations where additional flow tubes are installed within the internal cavity 20 (see for example FIG. 5D) the pack would not cover the area defined by the tube cross-section. In other words, the cross-section of the internal cavity 20 would exclude an area defined by a cross-section of the additional flow tube.

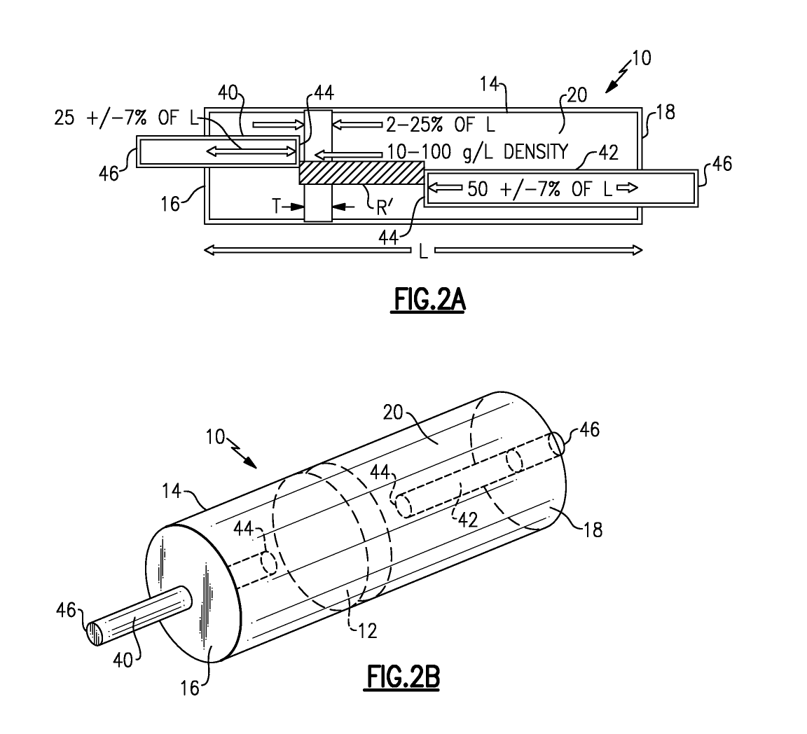

FIGS. 2A and 2B show an example that is similar to FIGS. 1A-1B, but which includes an additional noise reduction feature. In this example, the exhaust body 14 includes first and second ¼ wave tuners 40, 42 that extend into the internal cavity 20. Each ¼ wave tuner 40, 42 has an internal end 44 extending toward a center of the internal cavity 20 and an external end 46 extending away from the center and out of the exhaust body 14. In the example shown in FIGS. 2A-2B, the internal end 44 of one of the first 40 and the second 42 ¼ tuners is positioned at a distance within a range of 18% to 32% of the length from one of the first 16 and the second 18 ends along the axis A. The other of the first 40 and the second 42 ¼ wave tuners is positioned at a distance within a range of 43% to 57% of the length L from the other of the first 16 and the second 18 ends along the axis A. The pack 12 is positioned between the internal ends 44 of the first and the second ¼ wave tuners 40, 42. In this example, the pack 12 is positioned within a range R′ of 25% to 50% of the length L from either of the first 16 and second 18 ends along the axis A. The thickness T and density of the pack 12 would be similar to that disclosed above with regard to FIGS. 1A and 1B.

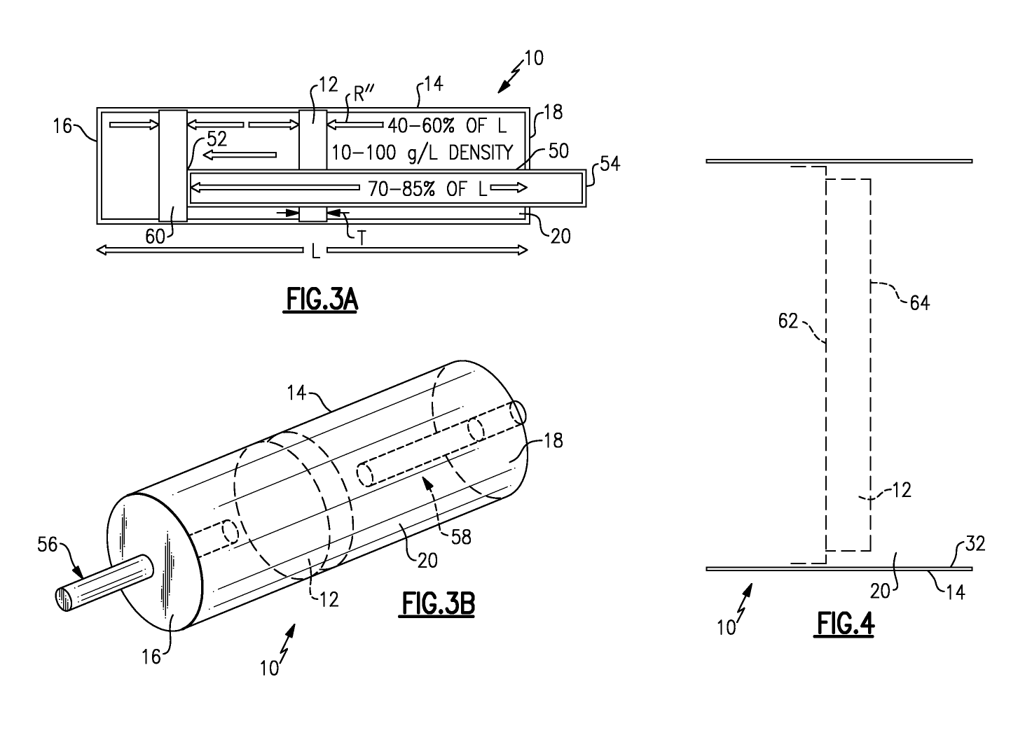

FIGS. 3A-3B disclose an example that is similar to FIGS. 2A-2B; however, only one ¼ wave tuner is used in this configuration. In this example, the exhaust body 14 supports one ¼ wave tuner 50 that has an internal end 52 positioned within the internal cavity 20 and an external end 54 extending outwardly of the internal cavity 20. The internal end 52 of the ¼ wave tuner 50 is positioned at a tuner distance within a range of 15% to 30 % of the length L from either of the first 16 and the second 18 ends along the axis A. FIG. 3B shows a first position 56 of the ¼ wave tuner 50 at the first end 16 and an optional second position 58 of the ¼ wave tuner 50 at the second end 18.

In the example shown in FIG. 3A, the internal end 52 of the ¼ wave tuner 50 is located 15% to 30% of the length L from the first end 16. The pack 12 is positioned within the range R″ of 40% to 60% of the length L and has the thickness T and density that is similar to the configurations discussed above. Additionally, a second pack 60 can be installed within the internal cavity 20 to further enhance the low frequency attenuation of the ¼ wave tuner. The second pack 60 is located at a distance that is no more than 20% of the length L along the axis A from the first end 16. In one example, the second pack 60 is located within a range of 0% to 20% of the first end 16 and can be located close to the internal end 52 of the ¼ wave tuner 50.

FIG. 4 shows an example where the exhaust body 14 includes a baffle 62 positioned within the internal cavity 20. The baffle 62 is installed in a traditional manner and the pack 12 is attached to the baffle 62. In one example the baffle 62 comprises a perforated baffle that extends across the entire cross-section of the internal cavity; however, the baffle could include additional openings to receive flow pipes and/or may only extend across a portion of the internal cavity 20.

The pack 12 is attached through use of a containment member 64 such as a perforated sheet metal and/or wire mesh that would completely contain the fibrous material but would be porous enough to be acoustically transparent. In one example, the containment member 64 is at least 20% porous. The density, location, and thickness of the pack 12 would be similar to that discussed above.

FIGS. 5A-5D show an example where an additional flow pipe 70 is installed within the internal cavity 20. In this example, the flow pipe 70 comprises a perforated pipe that is supported by the exhaust body 14 via an end cap or baffle, for example. In this example, a radially located pack 80 is mounted around an outer surface 82 of the flow pipe 70. The pack 80 completely surrounds the flow pipe 70 and extends along a substantial length of the perforated pipe 70, i.e. extends along almost an entire length of the pipe 70, leaving only small exposed pipe portions at each pipe end.

The pack includes an outer containment structure 84 that surrounds an outer surface of the pack 80. The outer containment structure 84 comprises a wire mesh tube, a perforated tube, a continuous wound fiber, a pre-form fiber that may or may not be resin impregnated, or other similar containment structures. The outer containment structure 84 is spaced apart from the internal wall of the cavity 20 by a gap 88. The thickness of the pack 80 is configured such that no more than 50% of the total cross-sectional area of the internal cavity 20 (less the cross-section of the flow pipe 70) is filled by the pack 80. One particularly beneficial configuration fills the internal cavity 20 within a range of 20% to 25%. Optionally, a second pack 90, similar to the pack 12 discussed above, can be positioned within the internal cavity 20 to surround the flow pipe 70. Further, the pack 80 and flow pipe 70 can be utilized in combination with any of the configurations discussed above.

As known, a fully compact exhaust component, such as a muffler, provides significant noise reduction compared to an empty muffler. The configurations set forth above, provide similar noise reduction characteristics and parameters as those found in a fully packed muffler but which significantly reduce the amount of packing material. This results in cost reductions and facilitates assembly.

Further, test results have proven that reducing pack size and locating the pack within certain predefined areas provides noise reduction capability that is comparable to a fully packed condition. The pack suppresses and/or dampens standing waves at discrete higher frequency levels. The pack is located in these areas where the velocities are higher than other areas within the muffler. The pack is not located in areas where velocities are lower. As a significant portion of the noise is generated at the higher frequency/higher velocity areas, locating the pack at these specific areas allows material to be removed from other areas without adversely affecting noise reduction.

The tuners were used in combination with the pack to further reduce noise for certain applications. Using these tuners alone can provide inconsistent results because subtle variations can cause significant changes in the transmission loss. Further, at high frequencies, such as higher that 1600 Hz, the ¼ tuners have been found not to provide sufficient noise suppression. However, when the pack is used in combination with a ¼ wave tuner a configuration is provided that has the benefits of both within a common muffler.

Further, optimized damping can be accomplished by installing the packing material within the ¼ wave tuner. The amount of packing within the tuner can be varied as needed to provide a desired result. In one example, 10-20 mm of material provides a good balance between the negative and positive benefits of damping the standing wave and the ¼ wave. Although a preferred embodiment of this invention has been disclosed, a worker of ordinary skill in this art would recognize that certain modifications would come within the scope of this invention. For that reason, the following claims should be studied to determine the true scope and content of this invention.

1. A vehicle exhaust component comprising:
an exhaust body having first and second opposing ends and defining an internal cavity with an inlet and an outlet where exhaust gases are directed through said exhaust body from said inlet to said outlet, and wherein said exhaust body is defined by a plurality of dimensions with one of said plurality of dimensions comprising a longest dimension; and
at least one pack comprised of a fibrous material and positioned within said internal cavity at a pack distance at least 20% of said longest dimension from either of said first and said second opposing ends along an axis defined by said longest dimension.

2. The vehicle exhaust component according to claim 1 wherein said pack has a thickness defined along said axis that is no more than 25% of said longest dimension.

3. The vehicle exhaust component according to claim 2 wherein said thickness is defined within a range of 2% to 25% of said longest dimension.

4. The vehicle exhaust component according to claim 1 wherein said pack distance is within a range of 20% to 60% of said longest dimension from either of said first and said second opposing ends along said axis.

5. The vehicle exhaust component according to claim 1 wherein said fibrous material has a density within a range of 10 to 150 grams per liter.

6. The vehicle exhaust component according to claim 1 wherein said exhaust body comprises an outer shell and wherein said internal cavity is defined by an inner wall of said outer shell, said internal cavity defining a cross-section comprising a plane that is normal to said axis, and wherein a cross-section of said pack covers the entire cross-section of said internal cavity.

7. The vehicle exhaust component according to claim 6 including at least one flow tube positioned within said internal cavity and wherein said cross-section of said internal cavity excludes an area defined by a cross-section of said at least one flow tube.

8. The vehicle exhaust component according to claim 1 wherein said pack comprises a single-piece, compressed disc-shaped body formed from said fibrous material, said disc-shaped body being defined by a thickness that is substantially less than said longest dimension.

9. The vehicle exhaust component according to claim 1 wherein said plurality of dimensions includes at least a component height, a component width, and a component length, and wherein said longest dimension comprises said component length.

10. The vehicle exhaust component according to claim 1 including at least one ¼ wave tuner having an internal end extending toward a center of said internal cavity and an external end extending away from said center, and wherein said internal end is positioned at a tuner distance within a range of 15% to 30% from either of said first and said second opposing ends along an axis defined by said longest dimension.

11. The vehicle exhaust component according to claim 10 wherein said pack distance is within a range of 40% to 60% from said either of said first and said second opposing ends.

12. The vehicle exhaust component according to claim 11 including an additional pack located adjacent said internal end at a distance no more than 20% of said longest dimension along said axis from said internal end.

13. The vehicle exhaust component according to claim 10 wherein said at least one ¼ wave tuner comprises first and second ¼ wave tuners with said internal end of one of said first and said second ¼ tuners being positioned at a distance within a range of 18% to 32% of said longest dimension from one of said first and said second opposing ends along said axis and with the other of said first and said second ¼ tuners being positioned at a distance within a range of 43% to 57% of said longest dimension from the other of said first and said second opposing ends along said axis, and wherein said pack is positioned between said internal ends of said first and said second ¼ tuners.

14. The vehicle exhaust component according to claim 1 including a baffle positioned within said internal cavity and wherein said pack is attached to said baffle.

15. The vehicle exhaust component according to claim 14 wherein said pack includes a perforated containment member that secures said pack to said baffle.

16. The vehicle exhaust component according to claim 1 including at least one perforated pipe positioned within said internal cavity and including a second pack mounted around an outer surface of said perforated pipe and extending along a substantial length of said perforated pipe.

17. The vehicle exhaust component according to claim 16 wherein said second pack includes an outer containment structure that surrounds an outer surface of said second pack, and wherein said outer containment structure is spaced apart from an internal wall of said exhaust body by a gap.

18. The vehicle exhaust component according to claim 1 wherein said exhaust body comprises a muffler outer shell.

19. A vehicle exhaust component comprising:
an exhaust body having first and second opposing ends and defining an internal cavity with an inlet and an outlet where exhaust gases are directed through said exhaust body from said inlet to said outlet, and wherein said exhaust body is defined by a plurality of dimensions with one of said plurality of dimensions comprising a longest dimension; and
at least one pack comprising a compacted single-piece body of fibrous material, said pack positioned within said internal cavity, and said pack having a thickness defined in a direction along an axis defined by said longest dimension wherein said thickness is no more than 25% of said longest dimension.

20. The vehicle exhaust component according to claim 19 wherein said pack is positioned within said internal cavity at a pack distance that is at least 20% of said longest dimension from either of said first and said second opposing ends along said axis defined by said longest dimension.

21. The vehicle exhaust component according to claim 20 wherein said thickness is defined within a range of 2% to 25% of said longest dimension and wherein said pack distance is within a range of 20% to 60% of said longest dimension from either of said first and said second opposing ends along said axis.

22. A vehicle exhaust component comprising:
an exhaust body having first and second opposing ends and defining an internal cavity with an inlet and an outlet where exhaust gases are directed through said exhaust body from said inlet to said outlet;
at least one perforated pipe positioned within said internal cavity; and
a single-piece pack comprised of a fibrous material and positioned within said internal cavity and mounted around an outer surface of said perforated pipe to extend along an entire length of said perforated pipe, and wherein said pack fills no more than 50% of a total open cross-sectional area of said internal cavity leaving a gap between an outer surface of said pack and an inner wall surface of said exhaust body.

23. The vehicle exhaust component according to claim 22 wherein said exhaust body is defined by a plurality of dimensions with one of said plurality of dimensions comprising a longest dimension, and including a second pack comprised of a fibrous material and having a thickness defined in a direction along an axis defined by said longest dimension wherein said thickness is no more than 25% of said longest dimension.

24. The vehicle exhaust component according to claim 22 wherein said exhaust body is defined by a plurality of dimensions with one of said plurality of dimensions comprising a longest dimension, and including a second pack comprised of a fibrous material and that is positioned within said internal cavity at a pack distance that is at least 20% of said longest dimension from either of said first and said second opposing ends along said axis defined by said longest dimension.

25. A method of assembling a pack within an exhaust component comprising the steps of:
(a) providing an exhaust body having first and second opposing ends and defining an internal cavity with an inlet and an outlet where exhaust gases are directed through the exhaust body from the inlet to the outlet, and wherein the exhaust body is defined by a plurality of dimensions with one of said plurality of dimensions comprising a longest dimension;
(b) defining a plurality of pack positions within said internal cavity;
(c) selecting at least one pack position based upon a desired noise reduction parameter; and
(d) positioning at least one pack comprised of a fibrous material in the pack position selected in step (c).

26. The method according to claim 25 including forming the pack to comprise a compacted single-piece body that has a thickness defined in a direction along an axis defined by the longest dimension wherein the thickness is no more than 25% of the longest dimension.

27. The method according to claim 25 wherein the pack positions are defined at a distance within a range of 20% to 60% of said longest dimension from either of the first and the second opposing ends along an axis defined by the longest dimension.

28. The method according to claim 25 including installing at least one perforated pipe within the internal cavity, and wherein the selected pack position comprises a position around an outer surface of the perforated pipe that extends along a substantial length of the perforated pipe, and including filling no more than 50% of a total open cross-sectional area of the internal cavity with the pack to leave a gap between an outer surface of the pack and an inner wall surface of the exhaust body.
